(19) United States
(12) Patent Application Publication
(10) Pub. No.: US 2009/0267421 A1
(43) Pub. Date: Oct. 29, 2009

(54) POWER CONVERTING DEVICE

(76) Inventor: Peng-Feng Kao, Taipei County (TW)

Correspondence Address: Muncy, Geissler, Olds & Lowe, PLLC, P.O. BOX 1364, FAIRFAX, VA, 22038-1364, US

(21) Appl. No.: 12/396,116

(22) Filed: Mar. 2, 2009

(30) Foreign Application Priority Data
Mar. 10, 2008 (TW) 097108286

(51) Int. Cl. H02J 1/00

(52) U.S. Cl. 307/151; 323/318

(57) ABSTRACT

A power converting device is disclosed, used in an electronic system for converting a first power into a second power. The power converting device includes a receiving module, a converting module and an output module. The receiving module is used for receiving the first power. The converting module is coupled to the receiving module for converting the first power into the second power according to at least one control signal. The output module is coupled to the converting module for outputting the second power.

### CROSS REFERENCE TO RELATED APPLICATIONS

This Application claims priority of Taiwan Patent Application No. 097108286, filed on Mar. 10, 2008, the entirety of which is incorporated by reference herein.

### BACKGROUND OF THE INVENTION

1. Field of the Invention

The invention relates to a power converting device, and more particularly to a power converting device used in an electronic system.

2. Description of the Related Art

Currently, electronic products, such as mobile phones, personal digital assistants (PDA), portable audio/video players, notebooks, and so forth are widely used due to portability thereof.

Thus, carrying more than two portable electronic products for a user is not uncommon. For carrying ease, a portable electronic product installs an accumulator to provide required power. The accumulator should be charged when the power is exhausted. Different battery chargers comprise different voltages and each electronic product has a matched battery charger. When multiple electronic products are used, various battery chargers are required.

FIGS. 1a and 1b are schematic views of charging for a portable electronic product using a battery charger. As shown in FIGS. 1a and 1b, when a notebook 10 and a mobile phone 12 are simultaneously used by a user, they are charged using corresponding battery chargers 14 and 16, respectively. When the user goes out, the battery chargers 14 should be carried together, so that the notebook 10 and the mobile phone 12 can be charged to prevent power exhaustion. Carrying multiple battery chargers, however, results in a heavy load for the user that brings inconvenience.

Thus, a power converting device used in an electronic system is desirable.

### BRIEF SUMMARY OF THE INVENTION

Power converting devices are provided. An exemplary embodiment of a power converting device used in an electronic system for converting a first power into a second power comprises a receiving module, a converting module, and an output module. The receiving module receives the first power. The converting module, coupled to the receiving module, converts the first power into the second power according to at least one control signal. The output module, coupled to the converting module, outputs the second power.

Power converting methods are provided. An exemplary embodiment of a power converting method used in an electronic system for converting a first power into a second power comprises the following. (a) The first power is received. (b) The first power is converted into the second power according to at least one control signal. (c) The second power is output.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIGS. 1a and 1b are schematic views of charging for a portable electronic product using a battery charger;

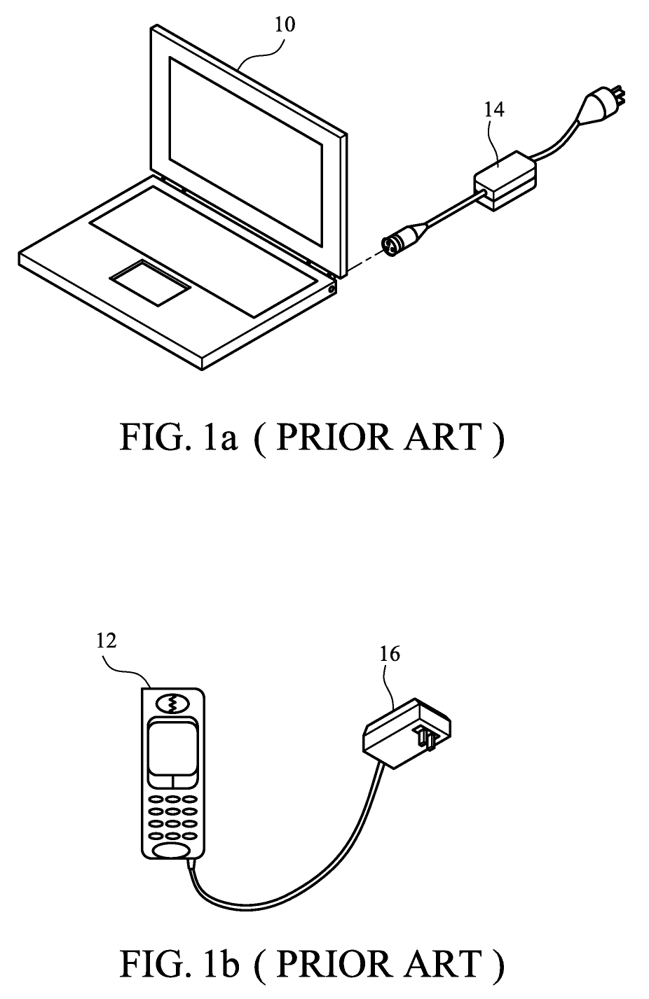

FIG. 2 is a schematic view of a power converting device used in an electronic system of the present invention;

FIG. 3 is a schematic view of the power converting device providing the second power for the portable electronic product of the present invention; and

FIG. 4 is a flowchart of a power converting method used in an electronic system of the present invention.

### DETAILED DESCRIPTION OF THE INVENTION

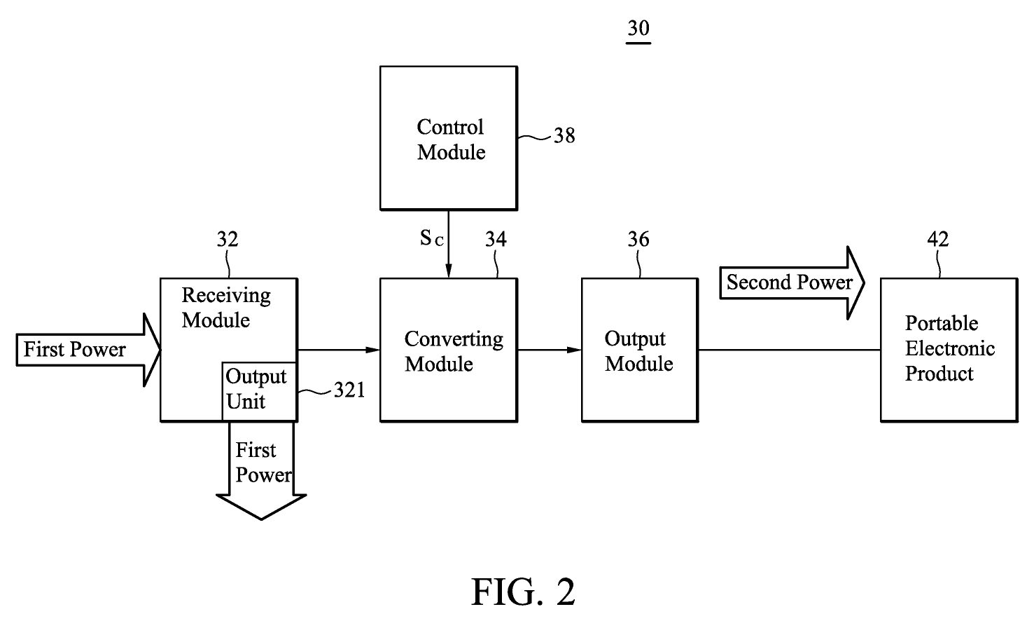

Several exemplary embodiments of the invention are described with reference to FIGS. 2 through 4, which generally relate to power converting for electronic products. It is to be understood that the following disclosure provides various different embodiments as examples for implementing different features of the invention. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

The invention discloses a power converting device and method used in an electronic system for converting a first power into a second power.

FIG. 2 is a schematic view of a power converting device used in an electronic system of the present invention. As shown in FIG. 2, an embodiment of a power converting device 30 used in an electronic system (not shown) converts a first power into a second power, comprising a receiving module 32, a converting module 34, and an output module 36. The receiving module 32 receives the first power. The converting module 34 couples to the receiving module and converts the first power into the second power according to at least one control signal S_{c}. The output module 36 couples to the converting module and outputs the second power.

The receiving module 32 comprises an output unit 321 for directly outputting the first power to the electronic system (not shown). In an embodiment, the electronic system (not shown) is a notebook.

The power converting device 30 further comprises a control module 38, coupled to the converting module 34, for generating control signal S_{c}.

The power converting device 30 further comprises a transmission unit 40, coupled to the output module 36 and a portable electronic product 42, for transmitting the second power to the portable electronic product 42. The transmission unit 40 is a transmission line. The second power output by the output module 36 is provided for the portable electronic product 42. In an embodiment, the portable electronic product 42 is a portable media player, a PDA, or a mobile phone.

In an embodiment, the output module 36 is a universal serial bus (USB) plug, coupled to a USB plug of the portable electronic product 42, providing the second power for the portable electronic product 42. In another embodiment, the output module 36 is a USB socket, coupled to a USB socket of the portable electronic product 42, providing the second power for the portable electronic product 42.

The converting module 34 further comprises a variable resistance and adjusts a resistance value of the variable resistance to further adjust capacity of the second power. In this embodiment, methods for adjusting the capacity of the second power are various and well known for those skilled in the art and are not limited to using the variable resistance. In another embodiment, the capacity of the second power can also be adjusted by controlling multiple series-connected switches comprising resistances based on the control signal Sc using a shunt.

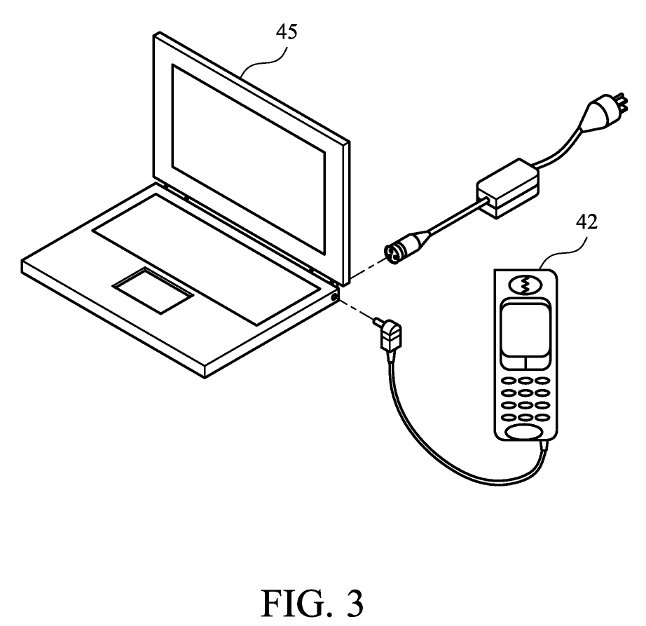

FIG. 2 is a schematic view of a power converting device used in an electronic system of the present invention. FIG. 3 is a schematic view of the power converting device providing the second power for the portable electronic product of the present invention. As shown in the FIGS. 2 and 3, the power converting device 30 provides power (the first power) for the notebook 45 and converts the power into a second type power (the second power) and provides the second type power for another portable electronic product 45, preventing inconvenience resulting from carrying multiple battery chargers for the portable electronic product 42.

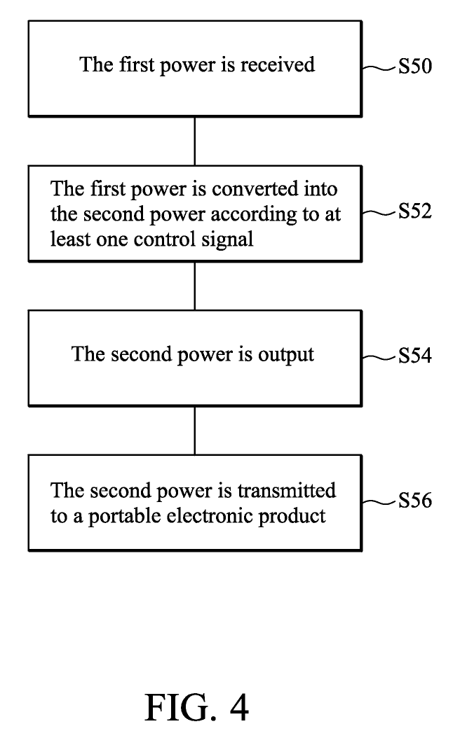

FIG. 4 is a flowchart of a power converting method used in an electronic system of the present invention. As shown in FIG. 4, an embodiment of a power converting method used in an electronic system (not shown) converts a first power into a second power

In step S50, the first power is received. In addition to receiving the first power, the step further comprises directly outputting the first power to the electronic system.

In step S52, the first power is converted into the second power according to at least one control signal. In an embodiment, the step comprises adjusting a resistance value of a variable resistance to further adjust capacity of the second power.

In step S54, the second power is output. The portable electronic product is a portable media player, a PDA, or a mobile phone.

In step S56, the second power is transmitted to a portable electronic product.

As described, an embodiment of a power converting device is installed inside a notebook and power input in the notebook is converted by a converting module of the power converting device to be provided for the notebook and converted into a second type power using the converting module to be provided for a second type portable electronic product. Thus, inconvenience resulting from carrying another batter charger for the second type portable electronic product is mitigated.

Methods and systems of the present disclosure, or certain aspects or portions of embodiments thereof, may take the form of a program code (i.e., instructions) embodied in media, such as floppy diskettes, CD-ROMS, hard drives, firmware, or any other machine-readable storage medium, wherein, when the program code is loaded into and executed by a machine, such as a computer, the machine becomes an apparatus for practicing embodiments of the disclosure. The methods and apparatus of the present disclosure may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the disclosure. When implemented on a general-purpose processor, the program code combines with the processor to provide a unique apparatus that operates analogously to specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A power converting device used in an electronic system for converting a first power into a second power, comprising:
a receiving module, receiving the first power;
a converting module, coupled to the receiving module, converting the first power into the second power according to at least one control signal; and
an output module, coupled to the converting module, outputting the second power.

2. The power converting device as claimed in claim 1, wherein the receiving module comprises an output unit for directly outputting the first power to the electronic system.

3. The power converting device as claimed in claim 2, wherein the electronic system is a notebook.

4. The power converting device as claimed in claim 2, further comprising a control module, coupled to the converting module, generating control signal.

5. The power converting device as claimed in claim 1, further comprising a transmission unit, coupled to the output module and a portable electronic product, transmitting the second power to the portable electronic product.

6. The power converting device as claimed in claim 5, wherein the transmission unit is a transmission line.

7. The power converting device as claimed in claim 1, wherein the output module is a universal serial bus (USB) plug, coupled to a USB plug of a portable electronic product, providing the second power for the portable electronic product.

8. The power converting device as claimed in claim 1, wherein the output module is a USB socket, coupled to a USB socket of a portable electronic product, providing the second power for the portable electronic product.

9. The power converting device as claimed in claim 1, wherein the converting module, further comprises a variable resistance, and adjusts a resistance value of the variable resistance to further adjust capacity of the second power.

10. The power converting device as claimed in claim 1, wherein the second power output by the output module is provided for a portable electronic product.

11. The power converting device as claimed in claim 10, wherein the portable electronic product is a portable media player, a PDA, or a mobile phone.

12. A power converting method used in an electronic system for converting a first power into a second power, comprising:
(a) receiving the first power;
(b) converting the first power into the second power according to at least one control signal; and
(c) outputting the second power.

13. The power converting method as claimed in claim 12, wherein the step (a) comprises: (a1) directly outputting the first power to the electronic system.

14. The power converting method as claimed in claim 13, wherein the electronic system is a notebook.

15. The power converting method as claimed in claim 12, further comprising: (d) transmitting the second power to a portable electronic product.

16. The power converting method as claimed in claim 12, wherein the step (b) comprises adjusting a resistance value of a variable resistance to further adjust capacity of the second power.

17. The power converting method as claimed in claim 12, wherein the second power is provided for a portable electronic product.

18. The power converting device as claimed in claim 17, wherein the portable electronic product is a portable media player, a PDA, or a mobile phone.
